(19) United States
(12) Patent Application Publication
(10) Pub. No.: US 2007/0264070 A1
(43) Pub. Date: Nov. 15, 2007

(54) Low Friction Cassette

(75) Inventors: Jurgen Van Loo, Lokeren (BE); Tom Schiettecat, Sint-Niklaas (BE); Kris Vandermeulen, Bornem (BE); Renaat Picqueur, Zele (BE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DYMO, Sint-Niklaas (BE)

(21) Appl. No.: 11/577,296

(22) PCT Filed: Oct. 14, 2005
(86) PCT No.: PCT/IB05/03477

§ 371 Date: Jun. 27, 2007

(30) Foreign Application Priority Data
Oct. 15, 2004 (GB) 0423010.8

(51) Int. Cl. B41J 35/28

(52) U.S. Cl. 400/207

(57) ABSTRACT

This invention relates to a cassette comprising a supply of image receiving tape, said cassette having at least one portion arranged to be in contact with said image receiving tape as said tape is drawn out of said cassette, said at least one portion have a surface with a coefficient of friction less than 0.4.

The present invention relates to a cassette for a tape printer and to a tape printer in combination with such a cassette.

Tape printers are known. They are arranged to operate with a supply of tape arranged to receive an image. Optionally, ink ribbon may be provided for-transferring an image on to the tape. Alternatively, an image can be printed directly on the tape using a thermal print head. In known tape printers, a tape holding case or cassette is arranged to hold a supply of image receiving tape. A supply of image transfer ribbon (ink ribbon) if provided, can be provided in the same cassette as the image receiving tape or in a different cassette. The image receiving tape and ink ribbon, where provided, are passed in overlap through a printing zone of the tape printer. A tape printer operating with a cassette of this type is described for example in EP-A-0267890 (Varitronic, Inc).

Other printing devices are known in which letters are transferred to an image receiving tape by a dry lettering or dry film impression process.

In the known tape printers, the construction of the image receiving tape generally takes the form of an upper layer for receiving an image which is secured to a releasable backing layer by a layer of adhesive. Once an image or message has been printed on the tape, it is desired to cut off that portion of the tape to enable it to be used as a label. Thus it is necessary to remove the releasable backing layer from the upper layer to enable the upper layer to be secured to a surface by means of the adhesive layer. In EP-A-267890 scissors are used to cut off the tape.

Another type of tape printer is described for example in EP-A-322919 (Brother) in which a cassette holds a supply of image receiving tape, a supply of image transfer ribbon and a supply of adhesive backing tape. The adhesive backing tape has an adhesive layer for contact with the image receiving tape, a substrate layer and a second adhesive layer covered by a releasable backing tape. The characters are printed on to the image receiving tape, which is transparent, as a mirror image.

A tape printer is also described for example in EP-A-487313 in the name of the present applicant. The tape cassette has a supply of image receiving tape and a supply of ink ribbon. The cassette includes a feed roller which is rotatably mounted and which cooperates with an output roller of the tape printer into which the cassette is inserted to feed the image receiving tape out of the tape printer after printing has taken place. After the tape has been fed out of the cassette, the printed portion of the tape is cut off by a cutting mechanism located outside the cassette boundary.

Reference is also made to EP-A-634275, also in the name of the present applicants, which describes a cassette arranged to hold a supply of ink ribbon and a supply of image receiving tape. In this arrangement, a platen is arranged to rotate. The platen co-operates with the print head. Rotation of the platen against the print head is arranged to draw the ink ribbon and image receiving tape out of the tape printer.

Originally, the image receiving medium was of paper or polyester (PET). It is now being proposed to use different materials for the image receiving medium. For example, it has been proposed to have an image receiving tape of a heat shrink tube material, a continuous tag material or the like. Generally, these materials are thicker than the originally proposed image receiving tape and have no backing layer. In the known cassettes, the backing layer is in contact with the cassette. The pull-out force to pull an image receiving medium with a paper backing layer is on average 1N, with an absolute peak force up to 1.9N. However, the pull-out force to pull an image receiving tape of heat shrink tube material, continuous tag material or the like, out of a cassette has peak forces up to 7N. This is because the coefficient of friction of paper is lower than that of for example heat shrink material or the like. Another factor to be taken into account is the weight of the material. Heat shrink material or the like may be heavier than the currently used materials. This means that the force required to pull the image receiving tape out of the cassette may be increased. In particular, it has been found that in some implementations, the driving force provided by the platen acting against the print head is insufficient to draw the image receiving tape from the cassette.

It is therefore an aim of embodiments of the present invention to address the above described problem.

According to a first aspect of the present invention, there is provided a cassette comprising a supply of image receiving tape, said cassette having at least one portion arranged to be in contact with said image receiving tape as said tape is drawn out of said cassette, said at least one portion have a surface with a coefficient of friction less than 0.4.

According to a second aspect of the present invention, there is provided a cassette comprising a supply of image receiving tape, said cassette having at least one portion arranged to be in contact with said image receiving tape as said tape is drawn out of said cassette, said at least one portion have a surface comprising Teflon.

According to a third aspect of the present invention, there is provided a method of making a cassette comprising the step of providing a cassette part for receiving a supply of image receiving tape, at least one portion of said cassette part having a surface with a coefficient of friction less than 0.4.

For a better understanding of the present invention and as to how the same may be carried into effect reference will now be made by way of example to the accompanying drawings in which:

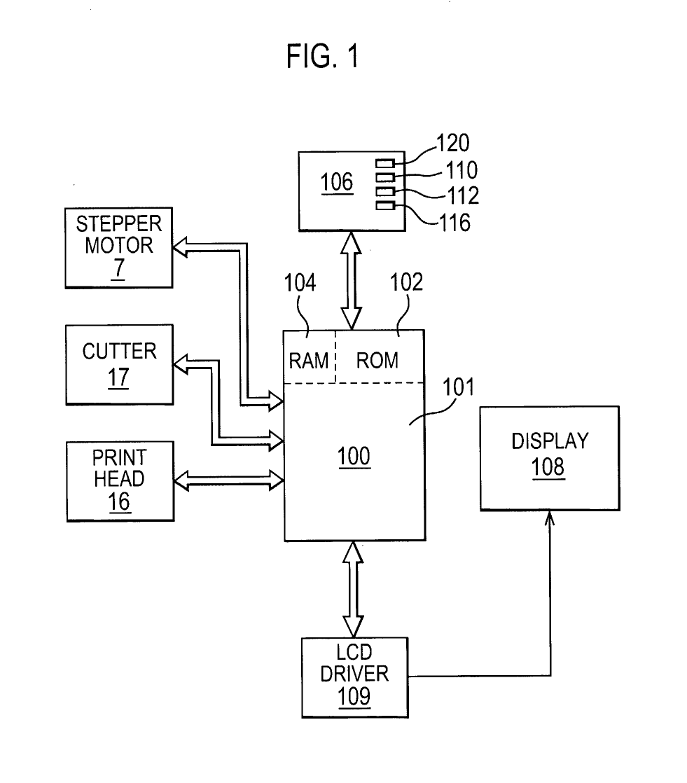

FIG. 1 is diagrammatic sketch showing the control circuitry for a tape printer in which embodiments of the present invention can be incorporated;

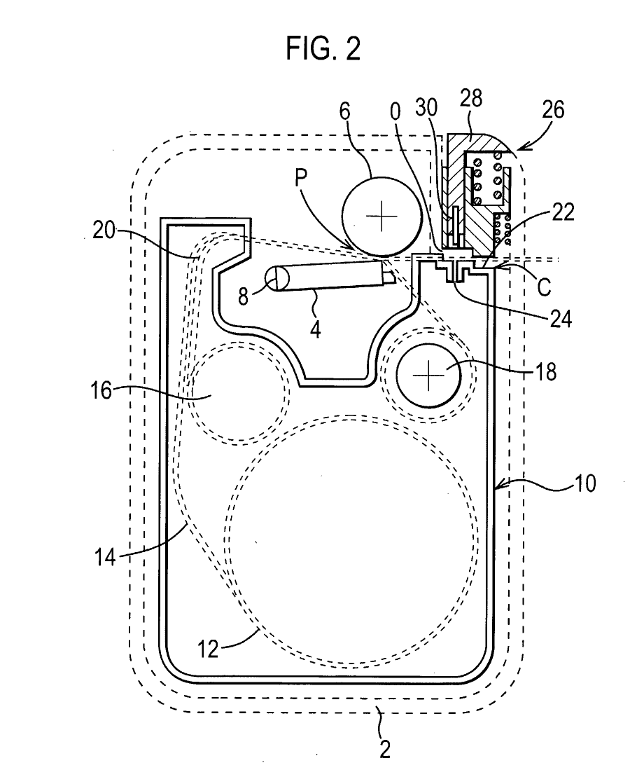

FIG. 2 is a plan view showing a one cassette system inserted in the tape printer;

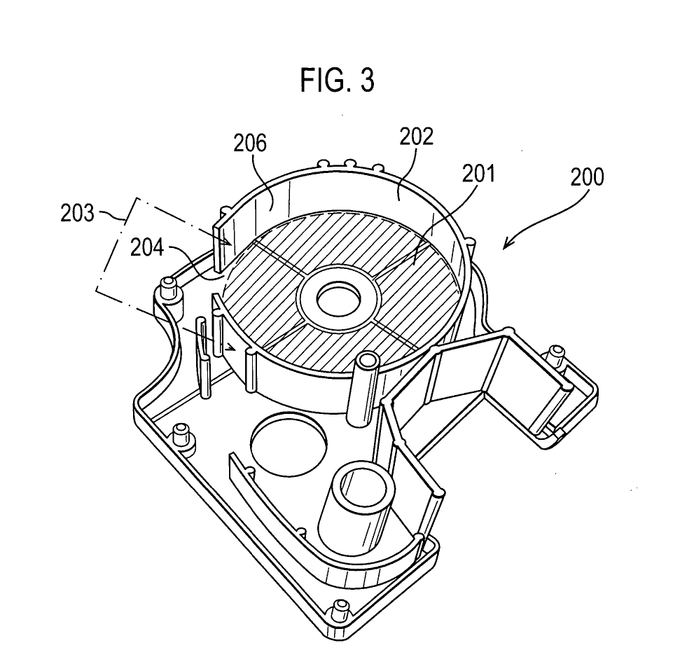

FIG. 3 shows part of the cassette of FIG. 2 in more detail, in one embodiment of the invention;

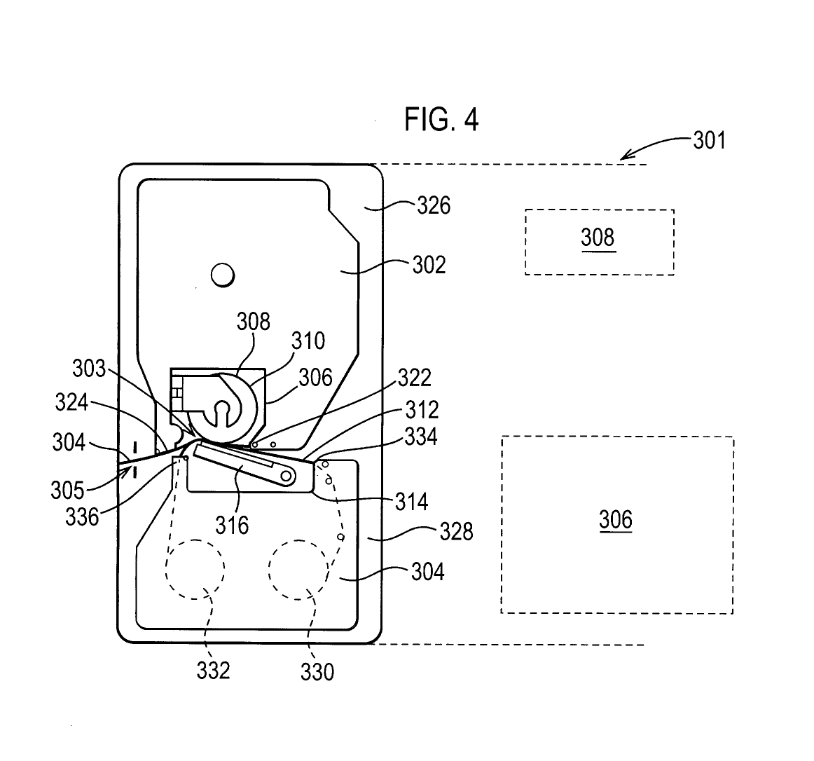

FIG. 4 shows a two cassette system in which embodiments of the invention can be incorporated;

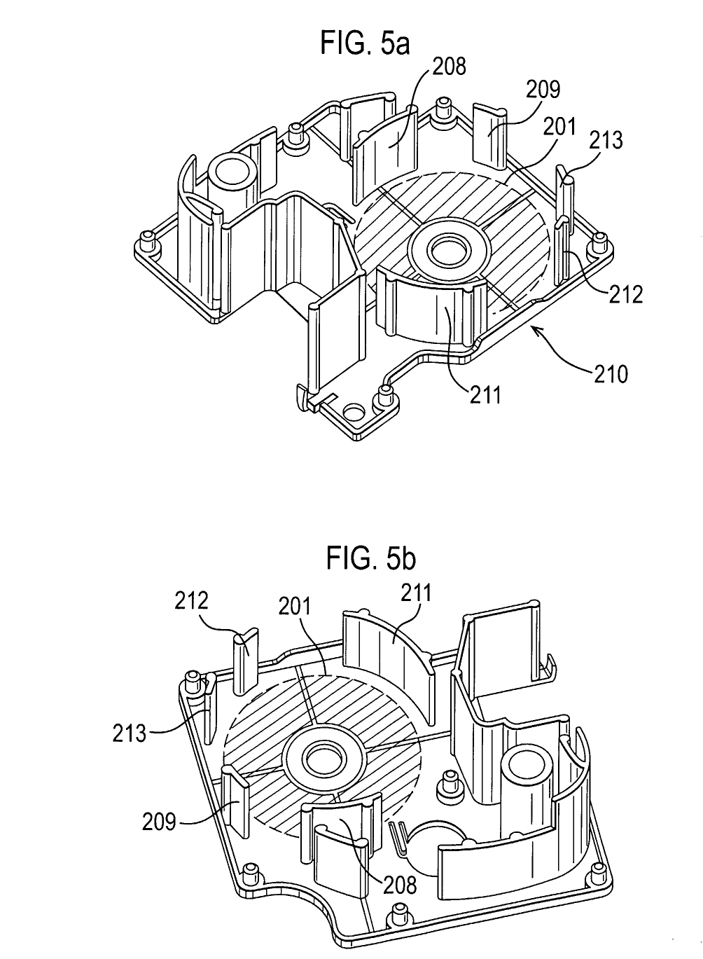

FIGS. 5a and 5b show part of the cassette of FIG. 2 in more detail in another embodiment of the invention;

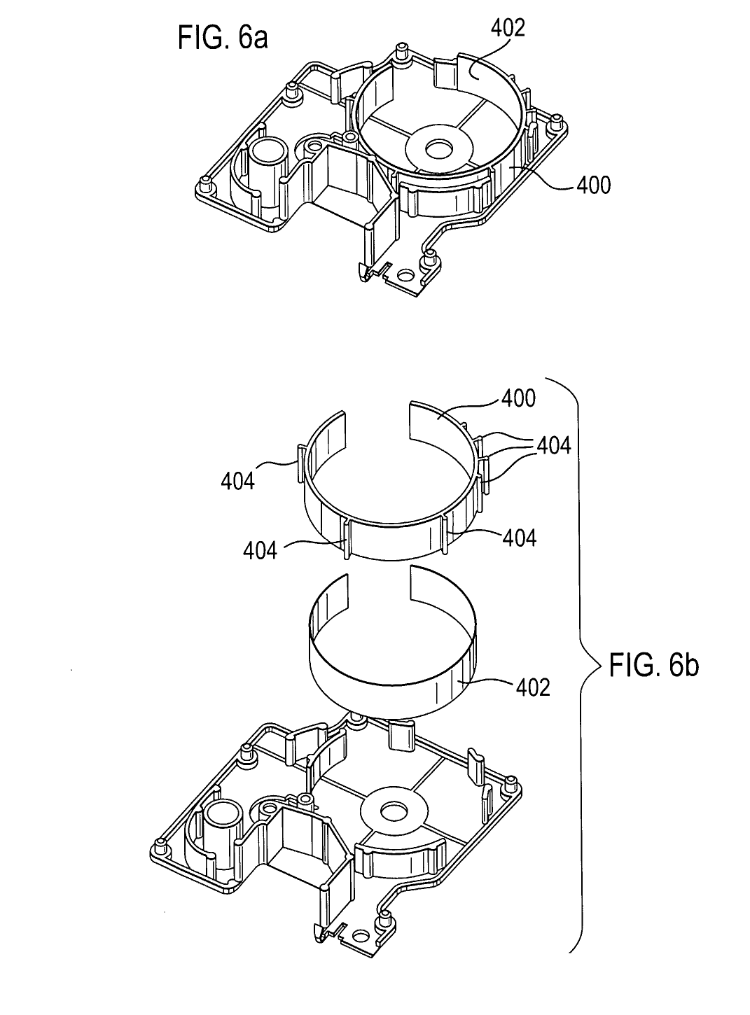

FIGS. 6a and 6b show a modified version of the cassette of FIGS. 5a and 5b.

The basic circuitry for controlling the tape printer is shown in FIG. 1. There is a microprocessor chip 100 having read only memory ROM 102, a microprocessor 101 and random access memory capacity indicated diagrammatically by RAM 105. The microprocessor is connected to receive data input to it from a data input device such as a keyboard 106. The microprocessor chip 100 outputs data to drive a display 108 via a display driver chip 109 and also to drive the print head and the motor for controlling the platen 8. The motor 7 may be a stepper motor or a DC motor controlled by an encoder arrangement or the like.

The microprocessor chip 100 also controls a cutting mechanism including a cutter 17 to cut off a length of printed tape. It should be appreciated that in some embodiments of the present invention, a manual cutter mechanism may be alternatively provided.

The operation of the tape printer will now be described. Data to be printed is input into the label printing device using the data input device, for example using keys on the keyboard 106. The data input keys are designated generally by block 109 but will in practice comprise a plurality of lettered and numbered keys. As the data is entered via the keyboard 106 it is supplied to the microprocessor 101 which causes the display 108 to display the data as it is entered. To do this, for each character which is entered, the microprocessor calls up a stored version of the character from the ROM 102. As the character is stored in compressed form, this font data is stored temporarily in the RAM 104 and is manipulated by the microprocessor 100 to generate pixel data to form the character. This pixel data is transmitted in one form to the display 108 and in another form to the print head for printing. Character data is not passed to the print head for printing until the print operation is executed.

Reference is now made to FIG. 2 which illustrates in plan view a cassette bay of the tape printer. The cassette bay is shown by the dotted line 2. The cassette receiving bay includes a thermal print head 4 and a platen 6 which co-operate to define a print location P in a manner which is known in the art. The print head 4 is pivotable about a pivot point 8 so that it can be bought into contact with a platen 6 for printing and moved away from the platen to enable a cassette to be removed and replaced.

The cassette inserted into the cassette bay is denoted generally by the reference number 10. The cassette holds a supply spool 12 of image receiving tape 14. In embodiments of the present invention, the image receiving tape 40 comprises a material with a relatively high co-efficient of friction. For example, the image receiving tape may comprise heat shrink tube material of polyolefin or continuous tag material of polypropylene or polyethylene with a thermal topcoat. These materials may or may not have a layer of adhesive attached to one side along with a backing layer. Embodiments of the invention can be used with backing layers with higher coefficients of friction than that usually provided by the know paper material. It should be appreciated that embodiments of the present invention are concerned with problems caused by the material of the image receiving tape (whether that be the side on which the image is received, or the reverse side which may or may not be provided with a backing layer) in contact with the cassette having a relatively high coefficient of friction. It should be appreciated that embodiments of the invention could have application where the top layer is in contact with the cassette or different materials are to be used with the tape as backing layer which have higher coefficients of friction.

The image receiving tape 14 is guided by a guide mechanism through the cassette, out of the cassette through an outlet 0, passed the print location P to a cutting location C. The cassette also has an ink ribbon supply spool 16 and an ink ribbon take up spool 18. The ink ribbon is guided from the ink ribbon supply spool 16 through the print location P and is taken up on the ink ribbon take up spool 18. The image receiving tape passes in overlap with the ink ribbon through the print location with the image receiving tape in contact with the ink ribbon.

The platen 6 is driven so that it rotates to drive the image receiving tape 14 past the print location for printing. In this way, tape is printed and fed out from the print location P to the cutting location C. The cutting location C may be provided at any suitable location, for example downstream of the cassette. However, in preferred embodiments of the present invention, the cutting location may be provided at a location on a portion of the wall of cassette 10 which is close to the print location P. As the tape is feed out of the cassette by driving the platen, there is no need for a further feed mechanism for the tape and this enables the cutting location C to be closer to the print location P.

The portion of the wall of the cassette where the cutting location C is defined is denoted by reference numeral 22. A slot is defined in the wall portion and the image receiving tape 14 is feed past the print location P to the cutting location C where it is supported by facing wall portion on either side of the slot. The tape printer includes a cutting mechanism generally denoted by reference numeral 26. This cutting mechanism includes a cutter support member 28 which carries a blade 30. The blade 30 cuts the image receiving tape and then enters the slot 24 with the leading part of its edge first, rather than bearing against an anvil.

Reference will now be made to FIG. 4 which shows in plan view two cassettes arranged in a tape printer. The upper cassette 302 is located in the first cassette receiving portion 326 and contains a supply of image receiving tape 304 which passes through a print zone 303 in the tape printer to an outlet 305 for the printer.

The cassette 302 has a recess 306 for accommodating a platen 308 of the printer and guide portions 322, 324 for guiding the tape 304 through the print zone. The platen 308 is mounted for rotation within a cage moulding 310. As an alternative, the platen 308 could be mounted for rotation on a pin. The lower cassette 304 is located in the second cassette receiving portion 328 and contains a thermal transfer ribbon which extends from a supply spool 330 to a take up spool 332 within the cassette 304. The thermal transfer ribbon 312 extends to the print zone 303 in overlap with the image receiving tape 304. The cassette 304 has a recess 314 for receiving a print head 316 of the printer and guide portions 334, 336 for guiding the ink ribbon 312 through the print zone 303.

The print head 316 is moveable between an operative position, shown in FIG. 4, in which it is in contact with the platen and holds the thermal transfer ribbon 312 and the image receiving tape in overlap between the print head and the platen and an inoperative position in which it is moved away from the platen to release the thermal transfer ribbon and image receiving tape. In the operative position, the platen is rotated to cause the image receiving tape to be driven past the print head and the print head is controlled to print an image on to the image receiving tape by thermal transfer of ink from the ribbon 312.

The print head is a conventional thermal print head having an array of pixels each of which can be thermally activated in accordance with the desired image to be printed.

The tape printer may have a lid which is not shown but which is hinged along the rear of the cassette receiving portion and which covers both cassettes when in place.

The basic control circuitry described in relation to FIG. 1 can also be used in the embodiment shown in FIG. 4.

The cassette 302 containing the image receiving tape may be as will be described in relation to FIG. 3, but without the support for the ink ribbon.

Thus, the first embodiment shows a cassette containing an ink ribbon and an image receiving tape. The cassette shown in FIG. 2 can be modified so as to only include the image receiving tape. FIG. 4 shows a two cassette system in which one cassette contains an image receiving tape and the other receives an ink ribbon.

The image receiving tape may have an image receiving layer and a backing layer. The outer surface of the supply of the image receiving tape may be the backing layer. The type of material of the backing layer can be different from the type of material of the image receiving tape. The type of material on the backing layer may be chosen so that the friction between the guided walls of the cassettes and the outer wall of the supplied image receiving tape is low. In some embodiments, there may be no backing layer.

Where a backing layer is provided it may be one of the following materials: smooth paper or any other material with a low coefficient of friction.

As already discussed, it should be appreciated that in some embodiments of the present invention, the image receiving tape will not require a backing layer. In that case, the outer surface of the supply of the image receiving medium is also the image receiving medium.

Examples of possible image receiving materials with which embodiments of the present invention can be used comprise heat shrink tube—made of polyolefin.

Another example is a supply of continuous tag insert material, a continuous tag insert being defined as non adhesive material that can be used as an insert in label holders of patch panels and outlets or which can be inserted in transparent label holders for example cable marking with cable ties. Examples of potential materials include polypropylene and polyethylene.

Reference is now made to FIG. 3 which shows part of the cassette of FIG. 2 but with part of the casing removed. The cassette 200 has a zone 201 marked with a circular disc. This zone 201 is for accommodating the supply of image receiving tape. Surrounding this zone 201 is a wall region 202. The wall 202 is arranged to define a generally circular shape. There is a gap 204 in the wall. This gap is to allow the image receiving medium to exit the supply zone. The wall 202 is made of a material with a relatively low co-efficient of friction or a material having a layer on the inside wall thereof with a low co-efficient friction. The preferred material is Teflon (Polytetrafluoroethylene, PTFE) or a Teflon coated material. Teflon has a coefficient of friction of 0.04 up to 0.4. Preferably the coefficient of friction is less than 0.15 and more preferably less than 0.1. More preferably, the coefficient of friction is 0.04 or less. Alternative materials having similarly low coefficients of friction may also be used.

The values for the coefficient of friction are for static or kinetic coefficients of friction. It should be appreciated that the coefficient of friction is determined by the interaction between the material of the tape in contact with the low friction material.

In embodiments of the present invention, the use of the low friction material is in order to provide a lower pulling out force. The pulling out force is the force required to pull the image receiving tape out of the cassette.

Tests were done to ascertain the force required to pull the image receiving medium out the cassette both for a new cassette and an aged cassette. The following values were calculated and are included in the table below:

| | | | | | | Abs |
|---|---|---|---|---|---|---|
| | Avg | Avg | Abs | Avg | Avg | Peak- |
| | POF | Peak | peak | POF-aged | Peak-aged | aged |
| Assembly 1 - | 112 | 168 | 756 | 135 | 199 | 795 |
| heat shrink | | | | | | |
| material in | | | | | | |
| contact with | | | | | | |
| Polystyrene, | | | | | | |
| the material | | | | | | |
| of the | | | | | | |
| cassette. | | | | | | |
| Assembly 2 - | 63 | 91 | 190 | 57 | 92 | 160 |
| paper backing | | | | | | |
| material in | | | | | | |
| contact with | | | | | | |
| cassette | | | | | | |
| material of | | | | | | |
| Polystyrene. | | | | | | |
| (= normal | | | | | | |
| cassette) | | | | | | |
| Assembly 3 | 108 | 140 | 233 | 132 | 208 | 648 |
| Release spray | | | | | | |
| (discussed | | | | | | |
| below) applied | | | | | | |
| to cassette | | | | | | |
| material of | | | | | | |
| Polystyrene | | | | | | |
| and heat | | | | | | |
| shrink | | | | | | |
| material | | | | | | |
| Assembly 4 | 97 | 118 | 180 | 94 | 123 | 214 |
| Teflon strip | | | | | | |
| 19 mm in width | | | | | | |
| in contact | | | | | | |
| with heat | | | | | | |
| shrink | | | | | | |
| material. | | | | | | |
| Assembly 5 | 86 | 102 | 128 | 100 | 121 | 167 |
| Teflon strip | | | | | | |
| 12 mm in width | | | | | | |
| in contact | | | | | | |
| with heat | | | | | | |
| shrink | | | | | | |
| material. | | | | | | |
| Assembly 6 | 99 | 138 | 212 | 130 | 178 | 511 |
| metal ring-in | | | | | | |
| contact with | | | | | | |
| heat shrink | | | | | | |
| material. | | | | | | |

average Pull-out-force (Avg POF)
average Peak of pull-out forces (Avg Peak)
absolute Peak of the pull-out forces (Abs Peak)
average Pull-out-force of an aged cassette (Avg POF-aged)
average Peak of pull-out forces (Avg Peak-aged)
absolute Peak of the pull-out forces (Abs Peak-aged)

As can be seen the use of Teflon provides a lower pull out force. The use of a release spray or metal ring may also improve the required pull out force.

A strip of material having the low co-efficient of friction is positioned on the inside surface 206 of the wall, and if the image receiving tape comes into contact with the surface of the wall there will be a low co-efficient friction there between. The strip can be Teflon. The Teflon strip can be adhered to the cassette using an adhesive or the like. The Teflon strip can partially or fully be adhered to the cassette.

In the arrangement illustrated in FIG. 3, the Teflon strip is adhered to wall portions 203 of the cassette. Two such wall portions 203 are provided, one on either side of the gap 204.

Teflon tape may be used which has an adhesive backing layer. In that implementation of embodiments of the present invention, the backing layer, of the strip of Teflon tape is partially removed at either end and fixed to the wall portions 203.

It should be appreciated that any other suitable technique can be used to secure the Teflon or any other low co-efficient of friction material to the cassette.

In an alternative embodiment of the present invention, an insert of a strip of material with a low co-efficient of friction can be placed in the cassette during the injection moulding process for manufacture of the cassette. Typically, the cassettes are made of injection moulded plastics material.

The result of this alternative will be similar to that shown in FIG. 3 but the wall portion 202 will be fixed onto the cassette, during the injection process. The wall will be an insert part and can be fixed in the cassette injection part at the time that the fluid material of the cassette becomes solid.

In one further alternative, the wall 202 can be made of the same material as the rest of the cassette during the injection moulding process. A layer of low co-efficient of friction material may then be subsequently applied to the wall.

A further alternative will now be described in relation to FIGS. 5a and 5b. In this alternative embodiment, a low co-efficient of friction coating is provided on the interior surface of the cassette. This can be on all of the inside surface of the cassette or can be a localised coating on certain of the surfaces. FIGS. 5a and 5b illustrate those portions which may be coated, where only a coating is provided on certain surfaces.

FIG. 5a shows the base portion of the cassette from one perspective whilst FIG. 5b shows the same portion of the cassette but from a different perspective. As with the embodiment of FIG. 3, the area occupied by the image receiving tape is marked 201. Surrounding this area are five wall portions 208, 209, 213, 212 and 211. These five wall portions are arranged generally in a circular configuration around area 201. These wall portions provide a guiding function to ensure that the image receiving medium remains generally in the area defined by reference 201 and also to guide the image receiving tape towards the outlet of the tape cassette.

The guiding wall portions in preferred embodiments of the present invention are generally curved in configuration so as to generally conform to the periphery of area 201. It should be appreciated that in some embodiments of the present invention, the walls may be generally flat. This would be particularly applicable where the wall portions are relatively small. The number and size of the wall portions can of course vary from embodiment to embodiment. The inside surfaces of each of wall portions 208 to 213 will be coated in one embodiment of the present invention.

In an alternative embodiment of the present invention, the inside of the cassette 210 can also be coated with a material having a low co-efficient of friction.

In one alternative of invention, an injection moulding part is provided which has a shape of an open ring, that is having a gap. The material of the injection moulded ring has a low co-efficient, of friction. The open ring is positioned in the cassette between the outer surface of the supply of the image receiving tape and the surface of the guiding walls in the defined zone for the supply of image receiving medium in the cassette. In other words, the ring could be received within the wall portions illustrated in FIG. 5. In this embodiment, the number of wall portions may be reduced. The injection moulded ring is placed in the cassette during manufacturer of the cassette. This can be used as an insert during manufacturer of the rest of the cassette or alternatively can be used as a separate part. The injection moulding part forming the base of the cassette has the correct shape and can be arranged with the ring in position and the cassette closed with the image receiving tape in place. In one modification, the wall portions can be omitted with just the ring being provided.

Reference is now made to FIGS. 6a and 6b. The cassette structure is similar to that shown in FIGS. 5a and 5b. However, a injection moulded ring 400 is provided. Inside the injection moulded ring 400 is a strip 402 of Teflon material. The Teflon strip. 402 is in the interior of the ring and contacts the tape material. In preferred embodiments of the present invention, the Teflon strip 402 is adhered to the interior of the injection moulded part using an adhesive. In one embodiment, the Teflon strip is a Teflon tape which has an adhesive backing layer. In an alternative embodiment of the present invention, the Teflon material may be held in place by any other means. If the Teflon material is sufficiently thick, an adhesive may not be required. Of course, materials other than Teflon may be used.

The outer ring 400 can be made of any suitable material. In preferred embodiments of the present invention, the exterior of the injection moulded part 400 can have one or more ribs 404. These ribs 404 are arranged to engage with portions of the cassette in order to retain the ring in the correct position. In alternative embodiments of the present invention, the ribs 404 may be used to provide a guide function in which they rest against appropriate members of the cassette to retain the ring in the correct position.

In an alternative embodiment of the present invention, the injection moulding part with guiding surfaces for the supply of image receiving medium can be produced in a material with a low co-efficient of friction. In other words, the whole of the cassette parts shown in FIGS. 3 and 5 can be made with a material having a low co-efficient of friction.

In an alternative, the part of the cassette shown for example in FIGS. 3 and 5 can be made with two materials. The material used for the guiding walls can be a material with a relatively low co-efficient of friction. The part of the cassette shown in FIGS. 3 and 5 would be used in two materials. The base of the cassette would be in one material and one or more of the guiding walls 208, 209, 211, 212 and 213 would be produced in a different material from the other part of the cassette.

In an alternative embodiment of the invention, the wall or wall portions surrounding the supply of image receiving tape can be coated with a release spray. The release spray is a silicon dry film.

In preferred embodiments of the invention, the wall or wall portions surrounding a tape supply have a relatively low coefficient of friction. It should be appreciated, that the cassette may have other guiding surfaces which may be in contact with the tape as it is drawn out of the cassette. Additionally or alternatively, these wall guiding surfaces may have a relatively low coefficient of friction.

It should be appreciated that embodiments of the present invention have been described in the context of reducing the pull out force for materials having a higher coefficient of friction but it should be appreciated that embodiments of the present invention can also be used to reduce the pull out force required for the known tape materials. This can have advantages in reducing the strain on the motor and/or improving battery life.

What is claimed is:

1. A cassette comprising a supply of image receiving tape, said cassette having at least one portion arranged to be in contact with said image receiving tape as said tape is drawn out of said cassette, said at least one portion have a surface with a coefficient of friction less than 0.4.

2. A cassette as claimed in claim 1, wherein said coefficient of friction is less than 0.15 and preferably less than 0.1.

3. A cassette as claimed in claim 1, wherein said coefficient of friction is substantially about 0.04 or less.

4. A cassette as claimed in claim 1, wherein said at least one portion comprises a wall portion arranged to substantially surround said supply of image receiving tape.

5. A cassette as claimed in claim 4, wherein said wall portion has at least one opening through which said image receiving tape is drawn from said supply.

6. A cassette as claimed in any of claim 1, wherein said at least one portion comprises a plurality of wall portions arranged around said supply of image receiving tape.

7. A cassette as claimed in claim 1 wherein said at least one portion comprises at least one guiding portion for guiding the image receiving tape through the cassette.

8. A cassette as claimed in claim 1, wherein at least part of said cassette has an interior coating having said coefficient of friction.

9. A cassette as claimed in claim 1, wherein said at least one portion is of a material having said coefficient of friction.

10. A cassette as claimed in any claim 1, wherein said at least one portion has a coating having said coefficient of friction.

11. A cassette as claimed in claim 10, wherein a release material is provided on said at least one portion to provide said coefficient of friction.

12. A cassette as claimed in claim 1, wherein at least part of said cassette comprises a material having said coefficient of friction.

13. A cassette as claimed in claim 12, wherein said at least one portion is inserted into cassette during injection molding of said cassette.

14. A cassette as claimed in claim 1, wherein said at least one portion is retained in said cassette by an adhesive.

15. A cassette as claimed in claim 1, wherein said at least one portion comprises a strip of material having a surface with said coefficient of friction.

16. A cassette as claimed in claim 15, wherein said strip is adhered to said cassette at either end thereof.

17. A cassette as claimed in claim 1, wherein said surface comprises Teflon.

18. A cassette as claimed in claim 1, wherein said image receiving tape comprises one of heat shrink material, polyester, polyolefin, polypropylene and polyethylene.

19. A cassette comprising a supply of image receiving tape, said cassette having at least one portion arranged to be in contact with said image receiving tape as said tape is drawn out of said cassette, said at least one portion have a surface comprising Teflon.

20. A tape printer in combination with a cassette as claimed in claim 1.

21. A method of making a cassette comprising the step of providing a cassette part for receiving a supply of image receiving tape, at least one portion of said cassette part having a surface with a coefficient of friction less than 0.4.

22. A method as claimed in claim 21 wherein said coefficient of friction is less than 0.15 and preferably less than 0.1.

23. A method as claimed in claim 21, wherein said coefficient of friction is substantially 0.04 or less.

24. A method as claimed in claim 21, comprising the step of providing as said at least one portion in said cassette part a wall portion arranged to substantially surround said supply of image receiving tape.

25. A method as claimed in claim 24, wherein said wall portion has at least one opening through which said image receiving tape is drawn from said supply.

26. A method as claimed in claim 21, comprising the step of providing in said cassette part as said at least one portion a plurality of wall portions arranged around said supply of image receiving tape.

27. A method as claimed in claim 21, comprising the step of providing in at least part of said cassette part an interior coating having said coefficient of friction.

28. A method as claimed in claim 21, comprising the step of providing said at least one portion of a material having said coefficient of friction.

29. A method as claimed in claim 21, comprising the step of providing on said at least one portion has coating having said coefficient of friction.

30. A method as claimed in claim 29, comprising the step of providing a release material on said at least one portion to provide said coefficient of friction.

31. A method as claimed in claim 21, providing said at least part of said cassette of a material having said coefficient of friction.

32. A method as claimed in claim 31, comprising the step of inserting said at least one portion in said cassette part during injection molding of said cassette part.

33. A method as claimed in claim 21, comprising the step of using adhesive to retain said at least one portion in said cassette.

34. A method as claimed in claim 21, comprising he step of providing a strip of material having a surface with said coefficient of friction as said at least one portion.

35. A method as claimed in claim 34, comprising the step of adhering said strip to said cassette part at either end thereof.

36. A method as claimed in claim 21, comprising the step of providing said surface of Teflon.

37. A method as claimed in claim 21, comprising the step of providing image receiving tape in said cassette part.

38. A method as claimed in claim 37, wherein said image receiving tape comprises one of one of heat shrink material, polyester, polyolefin, polypropylene and polyethylene.

39. A cassette comprising a supply of image receiving tape and a open ring in which said supply of image receiving tape is housed, said open ring having a Teflon layer on an interior surface of said ring.

40. A cassette as claimed in claim 39, wherein said Teflon layer comprises a Teflon tape.

41. A cassette as claimed in claim 40, wherein said Teflon tape is attached to said open ring by an adhesive.

42. A cassette as claimed in claim 39, wherein said open ring comprises an injection molded open ring.
